(19) United States
(12) Patent Application Publication
(10) Pub. No.: US 2010/0153215 A1
(43) Pub. Date: Jun. 17, 2010

(54) ENHANCED SEARCH RESULT RELEVANCE USING RELATIONSHIP INFORMATION

(75) Inventor: ROBIN ABRAHAM, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/431,453

(22) Filed: Apr. 28, 2009

Related U.S. Application Data
(60) Provisional application No. 61/122,334, filed on Dec. 12, 2008.

(51) Int. Cl. G06Q 30/00; G06F 17/30

(52) U.S. Cl. 705/14.55

(57) ABSTRACT

Systems and methods for utilizing information pertaining to one or more individuals or entities with whom a user has at least one pre-defined type of relationship (e.g., a social networking relationship) and information pertaining to the user's behavior with respect to the one or more individuals (e.g., manual designation, interaction with communications received from and/or sent to the user, and the like) to present relevant search results and/or advertisements to a user in response to receiving a search request are provided. Upon receiving a search request from a user, information about the user's relationships and behavior with respect to those relationships is utilized to determine user-relevant search results and/or advertisements. The search results and/or advertisements that are determined to be relevant to that particular user based upon the user's behavior and presented.

### RELATED APPLICATIONS

This application claims the benefit of U.S. Provisional Application Ser. No. 61/122,334, filed Dec. 12, 2008, incorporated herein by reference.

### BACKGROUND

Internet search engines provide users with access to a vast amount of information. Upon entering a search query into a search engine, a user receives a large number of search results reflecting the many interpretations of words comprising the search query. To better refine an internet search query, a user must add additional search query terms, or inputs, to better reflect the intent of the user's search query and reduce the large number of search results to a more manageable number.

### SUMMARY

Embodiments of the present invention relate to systems and methods for utilizing information pertaining to one or more individuals or entities with whom the user has at least one pre-defined type of relationship (e.g., a social networking relationship) and information pertaining to the user's behavior with respect to the one or more individuals (e.g., manual designation, interaction with communications received from and/or sent to the user, and the like) to present relevant search results and/or advertisements to a user in response to receiving a search request. While a user may have a large number of individuals or entities with whom the user shares a pre-defined relationship, embodiments of the present invention allow the user to distinguish between the individuals and/or entities the user has more interaction with and/or the user manually designates. Embodiments of the present invention allow only those individuals/entities with whom the user shares an evidenced similarity of taste and/or whom the user designates to influence the search results and/or advertisements presented to the user.

Embodiments of the invention are defined by the claims below, not this Summary. A high-level overview of various aspects of embodiments of the invention are provided here for that reason, to provide an overview of the disclosure, and to introduce a selection of concepts that are further described below. This Summary is not intended to identify key features or essential features of the claimed subject matter, nor is it intended to be used in isolation to determine the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 is a block diagram of an exemplary computing environment suitable for use in implementing embodiments of the present invention;

FIG. 2 is a schematic diagram showing an exemplary computing system architecture suitable for utilizing information pertaining to one or more individuals or entities with whom a user has a pre-defined relationship to enhance a user's search experience, in accordance with an embodiment of the present invention;

FIG. 3 is a flow diagram showing a method for enhancing the relevance of search results and advertisements utilizing information pertaining to one or more individuals or entities with whom a user has a pre-defined relationship, in accordance with an embodiment of the present invention;

FIG. 4 is a flow diagram showing a method for enhancing the relevance of search results and advertisements utilizing information included in at least one data repository, in accordance with embodiments of the present invention; and

FIG. 5 is a flow diagram showing a method for enhancing the relevance of search results utilizing information included in at least one data repository, in accordance with embodiments of the present invention.

### DETAILED DESCRIPTION

The subject matter of embodiments of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step”, “block”, and/or “component” etc. might be used herein to connote different components of methods or systems employed, the terms should not be interpreted as implying any particular order among or between various steps herein disclosed unless and except when the order of individual steps is explicitly described.

Embodiments of the present invention provide a system and method of utilizing information pertaining to one or more individuals or entities with whom the user has at least one pre-defined type of relationship (e.g., a social networking relationship) and information pertaining to the user's behavior with respect to the one or more individuals (e.g., manual designation, interaction with communications received from and/or sent to the user, and the like) in order to present relevant search results and/or advertisements to a user in response to receiving a search request. While a user may have a large number of individuals or entities with whom the user shares a pre-defined relationship, embodiments of the present invention allow the user to distinguish between the individuals and/or entities the user has more interaction with and/or the user manually designates. Embodiments of the present invention allow only those individuals/entities with whom the user shares an evidenced similarity of taste and/or whom the user designates to influence the search results and/or advertisements presented to the user.

In one embodiment, the present invention provides one or more computer-readable media having computer-executable instructions embodied thereon for performing a method for enhancing the relevance of information presented to a user in response to receiving a search request. The method comprises receiving a search request from a user, receiving information pertaining to one or more individuals with whom the user has at least one pre-defined type of relationship, receiving information pertaining to the user's behavior with respect to the one or more individuals, determining that at least one of a search result and an advertisement is relevant based upon the user's behavior, and presenting the at least one relevant search result or advertisement.

In another embodiment, the present invention provides one or more computer-readable media having computer-executable instructions embodied thereon for performing a method for enhancing the relevance of search results using relationship information. The method comprises receiving a search request from a user, referencing at least one data repository that includes information pertaining to one or more individuals with whom the user has at least one pre-defined type of relationship and information pertaining to the user's behavior with respect to the one or more individuals stored in association therewith, determining that at least one search result is relevant based upon the user's behavior, and presenting the at least one relevant search result.

A further embodiment of the present invention provides a method of enhancing the relevance of information presented to a user in response to receiving a search request. The method comprises receiving a search request from a user, referencing at least one data repository that includes information pertaining to one or more individuals with whom the user has at least one pre-defined type of social networking relationship and information pertaining to the user's behavior with respect to the one or more individuals stored in association therewith, determining that at least one search result is relevant based upon the user's behavior, and presenting the at least one relevant search result. The user's behavior includes at least one of manual selection of one or more individuals with whom the user has the at least one type of social networking relationship and behavior of the user with respect to communications sent to or received from the one or more individuals. In one aspect, an individual with whom the user has more contact based upon the user's behavior has more influence on the relevance of the at least one search result than an individual with whom the user has relatively less contact.

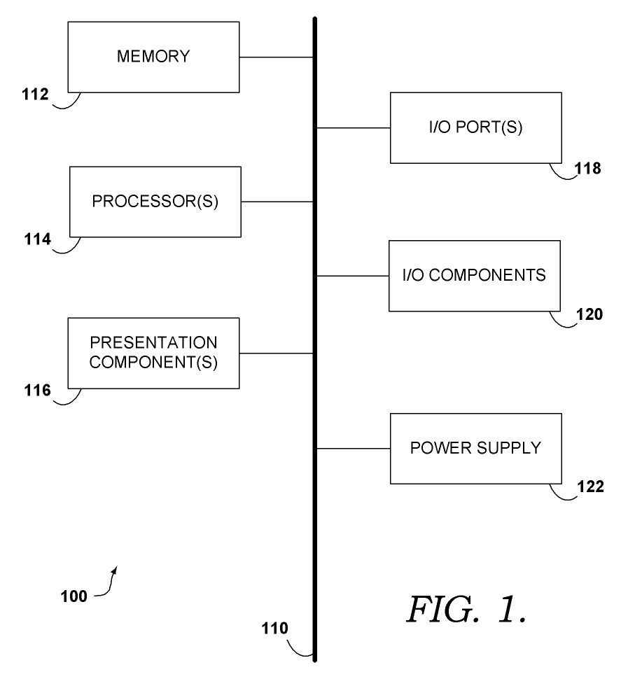

Having briefly described an overview of the present invention, an exemplary operating environment in which various aspects of the present invention may be implemented is now described. Referring to the drawings in generally, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventor hereof recognizes that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

I/O ports 118 allow the computing device 100 to be logically coupled to other devices including the I/O components 120, some of which may be built in. Illustrative components include a microphone, joystick, game pad, satellite dish, scanner, printer, wireless device, etc.

Embodiments of the present invention relate to systems and methods that utilize information pertaining to one or more individuals or entities with whom the user has at least one pre-defined type of relationship (e.g., a social networking relationship) and information pertaining to the user's behavior with respect to the one or more individuals (e.g., manual designation, interaction with communications received from and/or sent to the user, and the like) in order to present relevant search results and/or advertisements to a user in response to receiving a search request. In embodiments, the effectiveness of search results is improved based on a number of factors, including, but not limited to social networking, Internet content and user behavior. Embodiments of the present invention allow search results to be personalized as relevant to the user from whom a search request is received. Embodiments of the present invention are not limited to search results, but may also or alternatively apply to advertisements. As more fully described below, upon entering a search request, a user may have one or more search results determined to be relevant specifically to that user presented along with one or more relevant advertisements. Alternatively, embodiments of the present invention may relate only to procuring user-relevant advertisements.

Social networking has worked to establish and re-establish relationships between participants on social networking sites. In some networks, it is considered offensive to turn down an offer of a social-networking friendship. As a result, many users on social networking sites may choose to add one or more acquaintances as a “buddy” (that is, someone with whom they desire a social networking relationship) on a social networking site. The addition of acquaintances to one's social networking profile dilutes the ability for that user to use the social networking site to leverage the interests that may be shared among “buddies” who are genuinely close friends.

Embodiments of the present invention work to best exploit the information that can be found on a social networking site to reliably have individuals who have a pre-defined type of relationship with a user influence the search results and/or advertisements presented to the user, wherein individuals who have a pre-defined relationship with a user may be given weight to their influence based on the shared interests between the individual and the user. In another way, embodiments of the present invention permit a user to distinguish between social network relationships to allow those who are genuine friends to have greater influence over search results and advertisements than those social network relationships who may have been added as social networking buddies for other reasons.

A social network relationship may be manually selected by the user. A social network relationship may also be suggested to the user. As a user further defines his or her preferences and the criteria desired to be utilized in establishing such relationships, the user may preemptively decide to add one or more potential social network relationships who send a relationship request (that is, a request from an individual or an entity to the user requesting that the user add the individual or entity to the user's social network) to the user if the one or more potential social network relationships meet certain criteria (e.g., the individual went to high school with the user, the individual graduated from college with the user, or the like). The user may also preemptively select individuals who the user would accept as a social network relationship if the individual sends a relationship request.

When a user is distinguishing among social relationships, one of the factors that may be considered is the extent to which the user shares a similarity of taste with his social networking buddies. Similarity of taste is a factor that may be considered independently of whether or not a social networking relationship is a genuine friend or acquaintance. If an analysis shows that an individual shares a strong similarity of taste with a particular individual/entity, that social network relationship may be given additional weight in influencing the search results of a user, as more fully described below. Similarity of taste may be based on a buddy-by-buddy analysis, or it may be based on categories of interests. For instance, if the buddy of a user is found to share a strong similarity in taste with the user regarding movies, but has a strong dissimilarity of taste with the user regarding books, then the similarity of taste between that individual and the user regarding movies may be given more weight in the influence of the user's search results but not with respect to book choices.

A user may also independently add or delete particular buddies with respect to influence over the search results of a user. For instance, a user may add a high school friend as an influential buddy even though the user shares little in common with the high school buddy. The user may do this to have the high school friend's taste in categories have influence to remind the user of good times in high school, even though the user may not listen to high school-era music on a regular basis.

Moreover, the influence of a user need not be limited to individuals with whom the user shares a social networking relationship. The user may also be influenced by entities with whom the user shares a social networking relationship. For instance, the user may find that the daily music recommendations of a social networking site may strongly reflect the musical taste of the user. The user may sign up for the musical recommendations to be added to the user's favorite music lists, thereby creating a relationship between the user and the social networking entity that hosts the music recommendation list. Thus when a user submits a search request, the user may want the entity that hosts the music recommendation list to have influence of the search results of the user, at least with respect to music. Alternatively, the user may want the social networking entity to influence every aspect of the user's search results, regardless of category, because the recommendations from the social networking entity may reflect the overall most popular songs, movies, etc. and the user may be trying to keep in touch with the overall demographic population that uses a particular social networking website. For example, the user may be a comedian who needs to keep up on the general stream of what is popular in order to write jokes that will be meaningful to the greatest cross-section of a potential audience.

The influence of social networking relationships may be used to influence the search results of a user. The influence of social networking relationships may also be used to influence the advertisements presented to a user. When a user submits a search request, the influence of social networking relationships may influence the ranking of at least one of a search result and an advertisement. The phrase “at least one of a search result and an advertisement” is construed to mean the resulting ranking may influence a search result, an advertisement, a search result and an advertisement, a plurality of search results and an advertisement, a plurality of advertisements and a search result or a plurality of advertisements and a plurality of search results. Hereinafter, when search results are being discussed, it is understood that advertisements may be similarly influenced unless otherwise noted.

In addition to being influenced by social networking relationships, the search results of a user may be influenced by the interaction of a user with a social networking site and/or with individuals on a social networking site with whom the user has a pre-defined relationship. “Interaction of a user” may also be referred to as “user behavior.”

One way in which user behavior may be used to influence search results is the extent to which the user takes recommendations from buddies to follow web links. If a user is sent a web link from a social networking buddy and the user follows the web link, it may be reasoned that the user prefers to be influenced by the social networking buddy who sent the link. Similarly, if a user is sent a website and fails to follow the link, it may be reasoned that the user prefers to not be influenced by the social networking buddy who sent the link. This simple example, though, becomes more complex when a user is being sent the same link from multiple social networking buddies. In this scenario, the user may be considered to have “followed” the web link from each social networking buddy.

User interaction may also be based on the one or more categories a user chooses to define his preferences in a user profile. For instance, a use may define his favorite categories of music as Jazz and Blues. The user may choose his friends accordingly, manually selecting social networking buddies who each happen to have Jazz and Blues listed as their favorite music in their profile selection. At this point, the user's search results may be influenced more by the group of manually selected social networking buddies than it by his other social networking friends.

However, if a user fails to update his profile and his manually selected social networking buddies decide to change their musical preferences, the influence these social networking buddies of the user may have over music may be lessened. The influence may be lessened, even though the user manually selected the social networking buddies to influence his musical search results, because the manual selection of categories by the user as being reflective of the user's interests may be more influential in determining search results than the changing preferences of social networking buddies, even those social networking buddies who have been manually selected by the user.

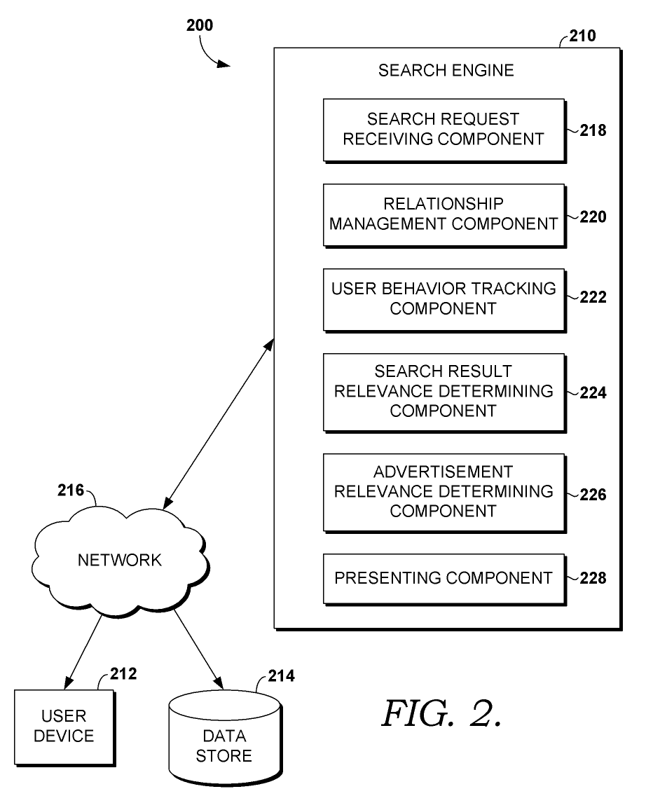

Turning now to FIG. 2, a block diagram is illustrated, in accordance with an embodiment of the present invention, that shows a system 200 configured to provide such an enhanced search experience for users. It will be understood and appreciated by those of ordinary skill in the art that the system 200 shown in FIG. 2 is merely an example of one suitable computing system and is not intended to suggest any limitation as to the scope of the use or functionality of embodiments of the present invention. Neither should the computing system 200 be interpreted as having any dependency or requirement related to any single component or combination of components illustrated therein. Further, the system 200 may be provided as a stand-alone product, as part of a software development environment, or any combination thereof.

The computing system 200 includes a search engine 210, a user device 212, and a data store 214, all in communication with one another via a network 216. The network may include, without limitation, one or more local area networks (LANs) and/or wide area networks (WANs). Such networking environments are commonplace in offices, enterprise-wide computer networks, intranets and the Internet. Accordingly, the network 216 is not further described herein.

The data store 214 is configured to store information related to search queries, user relationships (e.g., social networking relationships), user behavior (e.g., with respect to individuals or entities with whom the user has a pre-defined type of relationship, for instance, a social networking relationship), advertisements, and the like. In embodiments, the data store 214 is configured to be searchable for one or more of the items stored in association therewith. It will be understood and appreciated by those of ordinary skill in the art that the information stored in the data store 214 may be configurable and may include any information relevant to, at least, search queries, search results, user relationships, user behavior and advertisements. The content and volume of such information are not intended to limit the scope of embodiments of the present invention in any way. Further, though illustrated as a single, independent component, the data store 214 may, in fact, be a plurality of data stores, for instance, a database cluster, portions of which may reside on the search engine 210, the user device 212, another external computing device (not shown), and/or any combination thereof.

Each of the search engine 210 and the user device 212 shown in FIG. 2 may be any type of computing device, such as, for example, computing device 100 described above with reference to FIG. 1. By way of example only and not limitation, each of the search engine 210 and the user device 212 may be a personal computer, desktop computer, laptop computer, handheld device, mobile handset, consumer electronic device, and the like. Additionally, the user device 212 may further include a keyboard, keypad, stylus, joystick, and any other input-initiating component that allows a user to provide wired or wireless data to the network 216, e.g., search queries, user relationships, and the like. It should be noted, however, that the present invention is not limited to implementation on such computing devices, but may be implemented on any of a variety of different types of computing devices within the scope of embodiments hereof.

As shown in FIG. 2, the search engine 210 is configured to receive search queries or requests and present user-relevant search results and/or advertisements that satisfy the received request. The search engine 210 includes a search request receiving component 218, a relationship management component 220, a user behavior tracking component 222, a search result relevance determining component 224, an advertisement relevance determining component 226 and a presenting component 226. In some embodiments, one or more of the illustrated components 218, 220, 222, 224, 226 and 228 may be implemented as stand-alone applications. In other embodiments, one or more of the illustrated components 218, 200, 222, 224, 226 and 228 may be integrated directly into the operating system of the search engine 210 and/or the user device 212. It will be understood by those of ordinary skill in the art that the components 218, 220, 222, 224, 226 and 228 illustrated in FIG. 2 are exemplary in nature and in number and should not be construed as limiting. Any number of components may be employed to achieve the desired functionality within the scope of embodiments of the present invention.

The search request receiving component 218 is configured for receiving a search request from user. The search request may be received utilizing a variety of mechanisms known to those of ordinary skill in the art including, but not limited to, textual input into a specified display field utilizing a keyboard, stylus, or joystick associated with the user device 212. In one embodiment, the search request receiving component 218 receives search requests input by a user over the Internet.

The relationship management component 220 is configured to establish, modify, cancel and otherwise manage one or more predefined types of relationships between a user and other individuals and/or entities. The relationship management component 220 is further configured to perform several functions related to relationship lists including, without limitation, creating, deleting, and storing such relationship lists (for instance, in association with data store 214). A relationship list is a group of individuals and/or entities designated by an individual user as persons with whom the user desires to have a particular predefined type of relationship. In this regard, a relationship list may be the individual user's contact list, a user's social network, or the like. In another embodiment, the individual user and people on the individual user's relationship list must all subscribe to or sign up for a particular search service. In yet another embodiment, the relationship list may be unilaterally established by the user, that is, the individuals/entities placed on the user's relationship list may not need to consent to being on the relationship list. In yet another embodiment, the predefined type of relationship is bilateral meaning that an individual or entity must consent to being placed on the user's relationship list.

In embodiments, the relationship management component 220 may facilitate the creation of relationship lists. In this regard, the relationship management component 220 may allow users to edit the relationship list by adding individuals/entities to and/or subtracting individuals/entities from the list. If desired, the relationship management component 220 may provide an interface to allow the user to input identification information (e.g., name, email address, user ID, etc.) for individuals with whom a predefined type of relationship is established. The relationship management component 220 may also suggest persons from another predefined list for selection by the user. In a case where consent is required of an individual/entity prior to their being added to a relationship list, the relationship management component 220 may be further configured to contact the individual/entity to obtain the necessary consent. This consent may be requested, for instance, through use of a relationship request.

The relationship management component 220 may also be configured to allow a user to distinguish between individuals/entities with whom a relationship is established, allowing the user to designate one or more individuals/entities as having more influence over one or more types of search results and/or advertisements than the influence of other individuals/entities on the list. Use of individuals/entities with whom a user has a predefined type of relationship to influence search results and/or advertisements is more fully described below, for instance, with respect to search result relevance determining component 224.

A user may also designate (i.e., select) preferred individuals/entities to affect search results and/or advertisements based on categories, wherein a category may reflect an area of interest or commonality. Examples of categories include, without limitation, age groupings, cultural groupings (such as art or theatre), interest groups (such as a chess club or an ultimate Frisbee group), etc. For example, a user may designate a particular individual/entity as being particularly interesting with respect to music choices so that the preferences of that individual/entity will have increased influence, relative to another individual or entity with whom the user has the same type of predefined relationship but who is not similarly designated, over search results returned to the user when he or she inputs a search request relating to music. A user may designate another individual/entity as particular interesting with respect to each of “Music”, “Art” and “Restaurant Recommendations” so that the preferences of that particular individual/entity will have increased influence, relative to another individual or entity with whom the user has the same type of predefined relationship but who is not similarly designated, over search results returned when he or she inputs a search request relating to music, art, or restaurant recommendations.

The relationship management component 220 may be further configured to allow the user to block a particular individual/entity with whom a predefined type of relationship is established from having any influence over the search results or advertisements returned in response to an input search request. Similarly, the user may be permitted to block a particular individual/entity with whom a predefined type of relationship is established from having any influence over one or more categories of results or advertisements. For instance, a user may add his sister as an influential relationship, but block the sister from influencing search results or advertisements returned for a search request falling within the “Music” category. In this example, the sister's preferences would still influence every other applicable category, but would not be influential with regard to a search request entered by the user that relates to music.

The user behavior tracking component 230 is configured to facilitate the collection of user behavior information for individual users. Such user behavior may include, without limitation, the user's manual selection of an individual/entity with whom the user has a predefined type of relationship as influential over all search results and/or advertisements or only a portion of all search results and/or advertisements (e.g., a particular category), and the user's behavior with respect to communications received from and/or sent to individuals/entities with whom the user has a predefined type of relationship. Such user behavior with respect to communications may include, by way of example only, determining the user has viewed a communication received from an individual/entity, determining the user has ignored a communication received from an individual/entity and/or patterns of such behaviors. Additionally, such user behavior with respect to communications may include determining that the user has already seen at least a portion of a communication received from an individual/entity. In this latter instance, the user's behavior with respect to that communication may be discounted in influencing search result/advertisement relevance, as more fully described below.

In embodiments, the user behavior tracking component 230 may store (e.g., in association with data store 214) user behavior in response to suggested links to websites sent in a communication to the user. In one embodiment, the user behavior tracking component 230 may register in a data unit each time a web link is presented to the user, including in the data unit a reference to the individual or entity who referred the link to the user, an identifier to recognize the link and an indication whether the user followed the link once it was received. The user behavior tracking component 230 may additionally keep track of all individuals or entities who send the user a particular link, such as a link to a popular news program, and may register the individual or entity that the user relies on to follow the link. That individual or entity may then be given more influence, meaning the preferences of that individual or entity may be given more weight in assessing the best search result and/or advertisement to present to the user in response to a search request.

The search result relevance determining component 224 is configured for determining one or more search result items related to (e.g., that satisfy) a received search request that are especially relevant to the user. As such, in embodiments, the search result relevance determining component 224 parses the received search request into one or more search terms/phrases and compares the search term(s)/phrase(s) to a search index associated with a data store (for instance, data store 214). Data parsing and database indexing are well known to those of ordinary skill in the art and, accordingly, are not further described herein. The search result relevance determining component 224 may utilize a web crawler to index web-based properties (e.g., web pages or other web-based documents) to aid in the quickly finding and presenting user-relevant search results. The search result relevance determining component 224 may additionally apply one or more predefined algorithms to determine which search results are most relevant, both in a general sense and with respect to the user from whom the search request was received. In this regard, the search result relevance determining component utilizes information about the user's behavior, with respect to those individuals/entities with whom he or she has a predefined type of relationship (e.g., a social networking relationship), and weights the influence of those individuals/entities evidenced preferences against the user's behavior. Any search result items stored in association with a data store (e.g., data store 214) and referenced in the search index are compiled and a ranking algorithm that takes into account user relationships and user behavior with respect to those relationships is applied to determine how many of the satisfying results will be presented to the user and in what order.

The advertisement relevance determining component 226 is configured for determining one or more advertisements related to a received search request that are especially relevant to the user. As such, in embodiments, the advertisement relevance determining component 224 may apply one or more predefined algorithms to determine which advertisements are most relevant, both in a general sense and with respect to the user from whom the search request was received. In this regard, the advertisement relevance determining component 224 utilizes information about the user's behavior, with respect to those individuals/entities with whom he or she has a predefined type of relationship (e.g., a social networking relationship), and weights the influence of those individuals/entities evidenced preferences against the user's behavior. Any advertisements stored in association with a data store (e.g., data store 214) and referenced in an advertisement search index are compiled and a ranking algorithm that takes into account user relationships and user behavior with respect to those relationships is applied to determine how many user-relevant advertisements an the manner of presentation.

With respect to ranking algorithms utilized by either of the search result relevance determining component 224 and/or the advertisement relevance determining component 226, rules may be configured to establish the relative amount of weight various user behaviors have on the search result and/or advertisement ranking. By way of example only, and not limitation, a user's behavior in manually designating or selecting a particular individual/entity with whom he or she has a predefined type of relationship as a person he or she desires to have influence search results/advertisements overall or only within a particular category may be weighted more heavily that a user's behavior in accepting an individual as having the predefined type of relationship but who has not been specifically designated by the user to affect search results/advertisements. Additionally, user behavior that are more recent among a plurality of user behaviors may be weighted more heavily in influencing search results/advertisements to be presented than user behaviors that are relatively less recent. Still further, a user's behavior in setting up a particular preference may be given more weight in determining search results/advertisements than other user behaviors. Embodiments of the present invention are intended to include all such rules individually or in combination and the particular rules stated herein are not intended to limit the scope hereof.

The presenting component 228 is configured to present at least one search result and/or at least one advertisement to the user. Typically, such presentation will include a visual display of search results and/or advertisements (or selectable indicators thereof). However, other forms of presentation, such as audio presentation and/or audio/visual presentation, are contemplated to be within the scope hereof. If it is determined (e.g., utilizing search result relevance determining component 224 and/or advertisement relevance determining component 226) that one or more of the search results or advertisements is particularly relevant to the user, the presenting component 228 is further configured for prominently presenting that particular search result and/or advertisement. Such prominent presentation may include, but is not limited to, outlining the particular search result/advertisement, displaying the particular search result/advertisement in a different font relative to other displayed search results/advertisements, displaying the particular search result/advertisement in a different font size relative to other displayed search results/advertisements, displaying the particular search result/advertisement in a different font color relative to other displayed search results and/or advertisements, and displaying the particular search result/advertisement on an area of a display surface that is separated from other displayed search results/advertisements. In another embodiment, such prominent presentation includes copying the particular search result/advertisement (or the indicator(s) thereof) and displaying the copied search result/advertisement (or the indicator(s) thereof) to a prominent location on the display surface, e.g., to the top of a vertical listing of search results or advertisements. In this way, if the user frequently conducts the search request and is used to searching for a particular search result item in a particular location within the search results listing, the particular search result will still be in that location. In yet another embodiment, the particular search result/advertisement (or the indicator(s) thereof) may be moved such that the particular search result/advertisement (or the indicator(s) thereof) is displayed exclusively in a prominent location on the display surface. Any and all such variations, and any combinations thereof, are contemplated to be within the scope of embodiments of the present invention.

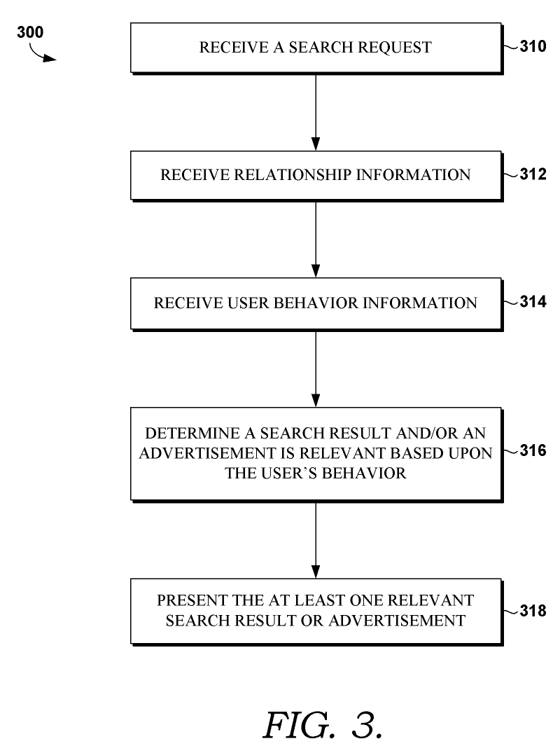

Turning now to FIG. 3, a flow diagram 300 is illustrated showing a method for enhancing the relevance of search results and advertisements utilizing information pertaining to one or more individuals or entities with whom a user has a pre-defined type of relationship, in accordance with embodiments of the present invention. At step 310, a search request is received from a user. By way of example, and with reference to FIG. 2, the user may input the search request (utilizing a keypad, stylus, or the like) at user device 212. The request may then be transmitted via network 216 to the search engine 210 and received by search request receiving component 218.

Returning to FIG. 3, at step 312, relationship information is received, the relationship information pertaining to one or more individuals with whom the user has at least one pre-defined type of relationship (e.g., a social networking relationship). By way of example only, such relationship information may be received from relationship management component 220 of FIG. 2. At step 314, user behavior information pertaining to the user's behavior with respect to the individual(s) with whom he or she has a predefined type of relationship is received, for instance, utilizing user behavior tracking component 222 of FIG. 2. By way of example only, such user behavior information may include the user's manual designation of an individual with whom he or she has a predefined type of relationship indicating that the particular individual is to influence the relevance all search results and/or advertisements or only a portion of search results/advertisements. As another example, such user behavior information may include behavior of the user with respect to communications sent to or received from the individual(s) with whom he or she has a predefined type of relationship.

Based on the received user behavior information, at step 316 a determination is made that at least one search result or advertisement is especially relevant to this particular user, e.g., utilizing search result relevance determining component 224 and/or advertisement relevance determining component 226 of FIG. 2. At step 318, the relevant search result/advertisement is presented to the user, e.g., utilizing presenting component 228 of FIG. 2.

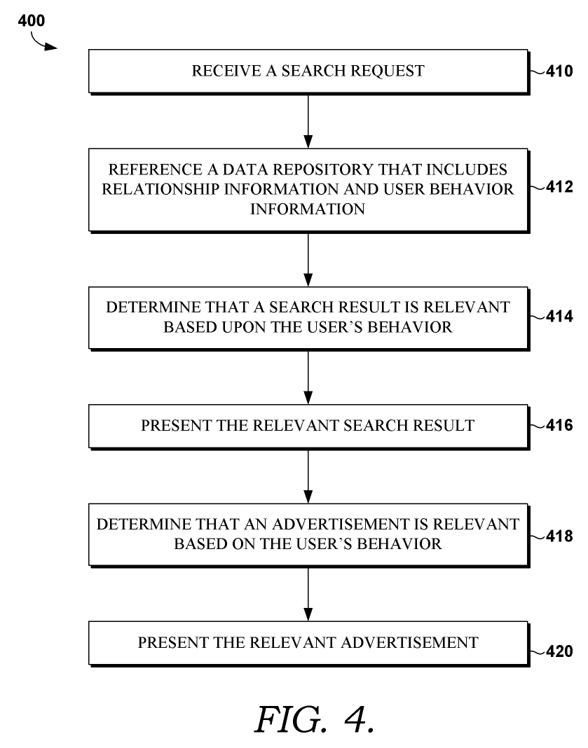

Turning now to FIG. 4, a flow diagram 400 is illustrated showing a method for enhancing the relevance of search results and advertisements utilizing information included in at least one data repository (e.g., data store 214 of FIG. 2), in accordance with embodiments of the present invention. At step 410, a search request is received from a user. By way of example, and with reference to FIG. 2, the user may input the search request (utilizing a keypad, stylus, or the like) at user device 212. The request may then be transmitted via network 216 to the search engine 210 and received by search request receiving component 218.

Returning to FIG. 4, at step 412, at least one data repository is referenced, e.g., data store 214 of FIG. 2. The data repository may include information pertaining to one or more individuals with whom the user has at least one predefined type of relationship (e.g., a social networking relationship), and information pertaining to the user's behavior with respect to the individual(s) with whom he or she has a predefined type of relationship stored in association therewith. By way of example only, such user behavior information may include the user's manual designation of an individual with whom he or she has a predefined type of relationship indicating that the particular individual is to influence the relevance all search results or only a portion of search results. As another example, such user behavior information may include behavior of the user with respect to communications sent to or received from the individual(s) with whom he or she has a predefined type of relationship.

Based on the received user behavior information, at step 414 a determination is made that at least one search result is especially relevant to this particular user, e.g., utilizing search result relevance determining component 224 of FIG. 2. At step 318, the relevant search result is presented to the user, e.g., utilizing presenting component 228 of FIG. 2.

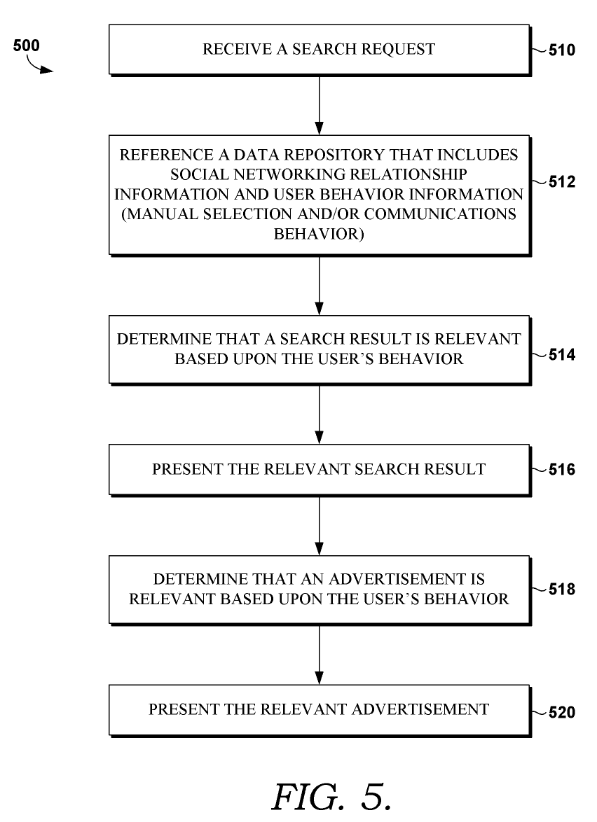

With reference now to FIG. 5, a flow diagram 500 is illustrated showing a method for enhancing the relevance of search results utilizing information included in at least one data repository (e.g., data store 214 of FIG. 2), in accordance with embodiments of the present invention. At step 510, a search request is received from a user. By way of example, and with reference to FIG. 2, the user may input the search request (utilizing a keypad, stylus, or the like) at user device 212. The request may then be transmitted via network 216 to the search engine 210 and received by search request receiving component 218.

At step 512, at least one data repository is referenced e.g., data store 214 of FIG. 2. The data repository may include information pertaining to one or more individuals with whom the user has a social networking relationship, and information pertaining to the user's behavior with respect to the individual(s) with whom he or she has a social networking relationship stored in association therewith. By way of example only, such user behavior information may include the user's manual designation of an individual with whom he or she has a social networking relationship indicating that the particular individual is to influence the relevance all search results or only a portion of search results. As another example, such user behavior information may include behavior of the user with respect to communications sent to or received from the individual(s) with whom he or she has social networking relationship.

Based on the received user behavior information, at step 514 a determination is made that at least one search result is especially relevant to this particular user, e.g., utilizing search result relevance determining component 224 of FIG. 2. At step 516, the relevant search result is presented to the user, e.g., utilizing presenting component 228 of FIG. 2. Similarly, at step 518, a determination is made that at least one advertisement is especially relevant to this particular user, e.g., utilizing advertisement relevance determining component 226 of FIG. 2. At step 520, the relevant advertisement is presented to the user, e.g., utilizing presenting component 228 of FIG. 2.

As can be understood, embodiments of the present invention provide systems and methods of utilizing information pertaining to one or more individuals or entities with whom the user has at least one pre-defined type of relationship (e.g., a social networking relationship) and information pertaining to the user's behavior with respect to the one or more individuals (e.g., manual designation, interaction with communications received from and/or sent to the user, and the like) in order to present relevant search results and/or advertisements to a user in response to receiving a search request. While a user may have a large number of individuals or entities with whom the user shares a pre-defined relationship, embodiments of the present invention allow the user to distinguish between the individuals and/or entities the user has more interaction with and/or the user manually designates. Embodiments of the present invention allow only those individuals/entities with whom the user shares an evidenced similarity of taste and/or whom the user designates to influence the search results and/or advertisements presented to the user.

The present invention has been described in relation to particular embodiments, which are intended in all respects to be illustrative rather than restrictive. Alternative embodiments will become apparent to those of ordinary skill in the art to which the present invention pertains without departing from its scope. From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of enhancing the relevance of information presented to a user in response to receiving search requests, the method comprising:
receiving a search request from a user;
receiving information pertaining to one or more individuals with whom the user has at least one pre-defined type of relationship;
receiving information pertaining to the user's behavior with respect to the one or more individuals;
determining that at least one of a search result and an advertisement is relevant based upon the user's behavior; and
presenting the at least one relevant search result or advertisement.

2. The one or more computer-readable media of claim 1, wherein the at least one pre-defined type of relationship comprises a social networking relationship.

3. The one or more computer-readable media of claim 1, wherein the user's behavior includes at least one of manual selection of one or more individuals with whom the user has the at least one pre-defined type of relationship and behavior of the user with respect to communications sent to or received from the one or more individuals.

4. The one or more computer-readable media of claim 3, wherein an individual having the at least one pre-defined type of relationship that is manually selected by the user has more influence in determining that at least one of a search result and an advertisement is relevant than an individual with whom the user has the at least one pre-defined type of relationship but who has not been manually selected by the user.

5. The one or more computer-readable media of claim 3, wherein the user's behavior further includes providing at least one user preference, and wherein the at least one user preference is given more weight in determining that at least one of a search result and an advertisement is relevant than other user behaviors.

6. The one or more computer-readable media of claim 3, wherein behavior of the user with respect to communications sent to or received from the one or more individuals comprises at least one of determining the user has viewed a communication received from one of the one or more individuals, determining the user has ignored a communication received from one of the one or more individuals, and determining the user has already seen at least a portion of a communication received from one of the one or more individuals.

7. The one or more computer-readable media of claim 1, wherein user behavior that is more recent among a plurality of user behaviors is given more weight in determining that at least one of a search result and an advertisement is relevant than less recent user behavior among the plurality of user behaviors.

8. The one or more computer-readable media of claim 1, wherein relevance of at least one of the search result and the advertisement is determined with respect to all search results and advertisements for the user or only a portion of all of the search results or advertisements.

9. The one or more computer-readable media of claim 8, wherein relevance of at least one of the search result and the advertisement is determined with respect to only a portion of all of the search results or advertisements, and wherein the portion represents an information category.

10. One or more computer-readable media having computer-executable instructions embodied thereon for performing a method of enhancing the relevance of search results using relationship information, the method comprising:
receiving a search request from a user;
referencing at least one data repository, wherein the at least one data repository includes information pertaining to one or more individuals with whom the user has at least one pre-defined type of relationship, and wherein the at least one data repository further includes information pertaining to the user's behavior with respect to the one or more individuals;
determining that at least one search result is relevant based upon the user's behavior; and
presenting the at least one relevant search result.

11. The one or more computer-readable media of claim 10, wherein the at least one pre-defined type of relationship comprises a social networking relationship.

12. The one or more computer-readable media of claim 10, wherein the user's behavior includes at least one of manual selection of one or more individuals with whom the user has the at least one pre-defined type of relationship and behavior of the user with respect to communications sent to or received from the one or more individuals.

13. The one or more computer-readable media of claim 10, wherein user behavior that is more recent among a plurality of user behaviors is given more weight in determining that at least one of a search result and an advertisement is relevant than less recent user behavior among the plurality of user behaviors.

14. The one or more computer-readable media of claim 10, wherein the method further comprises:
determining that at least one advertisement is relevant based upon the user's behavior; and
presenting the at least one relevant advertisement.

15. The one or more computer-readable media of claim 10, wherein relevance of the at least one search result is determined with respect to all search results for the user or only a portion of all of the search results.

16. The one or more computer-readable media of claim 15, wherein relevance of the at least one search result is determined with respect to only a portion of all of the search results, and wherein the portion represents an information category.

17. A method of enhancing the relevance of information presented to a user in response to receiving search requests, the method comprising:
receiving a search request from a user;
referencing at least one data repository, wherein the at least one data repository includes information pertaining to one or more individuals with whom the user has at least one pre-defined type of social networking relationship, and wherein the data repository further includes information pertaining to the user's behavior with respect to the one or more individuals stored in association therewith;
determining that at least one search result is relevant based upon the user's behavior, wherein the user's behavior includes at least one of manual selection of one or more individuals with whom the user has the at least one type of social networking relationship and behavior of the user with respect to communications sent to or received from the one or more individuals, and wherein an individual with whom the user has more contact based upon the user's behavior has more influence on the relevance of the at least one search result than an individual with whom the user has relatively less contact; and
presenting the at least one relevant search result.

18. The method of claim 17, further comprising:
determining that at least one advertisement is relevant based upon the user's behavior; and
presenting the at least one relevant advertisement.

19. The method of claim 17, wherein relevance of the at least one search results is determined with respect to all search results for the user or only a portion of all of the search results.

20. The method of claim 19, wherein relevance of the at least one search result is determined with respect to only a portion of all of the search results, and wherein the portion represents an information category.
